(19) United States
(12) Patent Application Publication
(10) Pub. No.: US 2026/0057863 A1
(43) Pub. Date: Feb. 26, 2026

(54) AUDIO DATA PROCESSING DEVICE, AUDIO DATA PROCESSING METHOD, AND PROGRAM

(71) Applicant: AlphaTheta Corporation, Yokohama-shi, Kanagawa (JP)

(72) Inventors: Shiro Suzuki, Yokohama-shi, Kanagawa (JP); Hajime Yoshino, Yokohama-shi, Kanagawa (JP); Kei Sakagami, Yokohama-shi, Kanagawa (JP)

(21) Appl. No.: 19/102,648

(22) PCT Filed: Aug. 12, 2022
(86) PCT No.: PCT/JP2022/030732

§ 371 Date: Feb. 10, 2025

(51) Int. Cl. G10H 1/00

(52) U.S. Cl. CPC G10H 1/0025; G10H 2210/076

(57) ABSTRACT

A data processing device including: a first audio analyzer that extracts, from audio data of a music piece including a first part and a second part that are acoustically separable from each other, audio data of the first part; a second audio analyzer that generates, from the audio data of the music piece, data of a unit sound of the second part; a third audio analyzer that generates, from the audio data of the music piece, data indicating a sounding position of the second part; a master tempo processor that performs master tempo processing on audio data including at least the first part; and a mixing processor that generates audio data in which the audio data of the first part subjected to the master tempo processing is mixed with audio data of the second part, the audio data of the second part being configured by relocating a sound of the second part.

### TECHNICAL FIELD

The present invention relates to an audio data processing device, an audio data processing method, and a program.

### BACKGROUND ART

Master tempo processing has already been known that changes only a tempo without changing a key of a music piece by a device such as a DJ device. For example, Patent Literature 1 discloses a digital player including a master tempo adjustment slider that adjusts a playback speed of a track.

### CITATION LIST

### Patent Literature(s)

Patent Literature 1: International Publication No. WO 2017/119115

### SUMMARY OF THE INVENTION

### Problem(s) to be Solved by the Invention

For example, when a tempo of a music piece is greatly changed by master tempo processing, it is possible to change the tempo without allowing a change in timbre to be recognized for a vocal sound or a pitched musical instrument sound, whereas, for a sound of an instrument belonging to, for example, a percussion instrument group, the change in timbre due to the tempo change can be recognized. Such a phenomenon is caused by a difference between: a sound produced as a continuous waveform; and a sound produced as a waveform having a characteristic time series variation, for example, an attack followed by a roar in a drum sound. In the latter case, if a length of the waveform is changed by the master tempo processing, the change in timbre is easily recognizable.

It is therefore an object of the invention to provide an audio data processing device, an audio data processing method, and a program that make it possible to prevent a change in timbre before and after master tempo processing from being recognized easily even for a kind of sound such as a percussion instrument sound.

### Means for Solving the Problem(s)

An audio data processing device including: a first audio analyzer that extracts, from audio data of a music piece including a first part and a second part that are acoustically separable from each other, audio data of the first part; a second audio analyzer that generates, from the audio data of the music piece, data of a unit sound of the second part; a third audio analyzer that generates, from the audio data of the music piece, data indicating a sounding position of the second part; a master tempo processor that performs master tempo processing on audio data including at least the first part; and a mixing processor that generates audio data in which the audio data subjected to the master tempo processing is mixed with audio data of the second part, the audio data of the second part being configured by relocating the unit sound of the second part in accordance with the data indicating the sounding position of the second part.

The audio data processing device according to [1], in which the master tempo processor performs master tempo processing on the audio data of the first part.

The audio data processing device according to [1], in which the master tempo processor performs master tempo processing on the audio data of the music piece, the first audio analyzer extracts, from the audio data of the music piece subjected to the master tempo processing, the audio data of the first part, and the second audio analyzer generates, from the audio data of the music piece before being subjected to the master tempo processing, the data of the unit sound of the second part.

The audio data processing device according to any one of [1] to [3], in which the second part includes a percussion instrument sound, and the first part includes a sound other than the percussion instrument sound.

The audio data processing device according to [4], in which the percussion instrument sound includes a kick sound.

A data processing method including: extracting, from audio data of a music piece including a first part and a second part that are acoustically separable from each other, audio data of the first part; generating, from the audio data of the music piece, data of a unit sound of the second part; generating, from the audio data of the music piece, data indicating a sounding position of the second part; performing master tempo processing on audio data including at least the first part; and generating audio data in which the audio data subjected to the master tempo processing is mixed with audio data of the second part, the audio data of the second part being configured by relocating the unit sound of the second part in accordance with the data indicating the sounding position of the second part.

A program for causing a computer to achieve functions of: extracting, from audio data of a music piece including a first part and a second part that are acoustically separable from each other, audio data of the first part; generating, from the audio data of the music piece, data of a unit sound of the second part; generating, from the audio data of the music piece, data indicating a sounding position of the second part; performing master tempo processing on audio data including at least the first part; and generating audio data in which the audio data subjected to the master tempo processing is mixed with audio data of the second part, the audio data of the second part being configured by relocating the unit sound of the second part in accordance with the data indicating the sounding position of the second part.

With the above-described configurations, when a tempo of the audio data of the music piece is to be changed, the audio data of the first part subjected to the master tempo processing is mixed with the audio data of the second part that is configured by relocating the unit sound of the second part in accordance with the data indicating the sounding position of the second part. This makes it possible to prevent a change in timbre before and after master tempo processing from being recognized easily even for a kind of sound such as a percussion instrument sound.

### BRIEF DESCRIPTION OF DRAWINGS

FIG. 1 illustrates an overall configuration of a system according to a first exemplary embodiment of the invention.

FIG. 2 is a block diagram illustrating a schematic functional configuration of an audio data processing device in an example illustrated in FIG. 1.

FIG. 3 schematically illustrates master tempo processing in the example illustrated in FIG. 1 in comparison with ordinary master tempo processing.

FIG. 4 is a flowchart illustrating a process performed by the audio data processing device in the example illustrated in FIG. 1.

FIG. 5 is a block diagram illustrating a schematic functional configuration of an audio data processing device according to a second exemplary embodiment of the invention.

FIG. 6 is a flowchart illustrating a process performed by the audio data processing device in an example illustrated in FIG. 5.

### DESCRIPTION OF EMBODIMENT(S)

### First Exemplary Embodiment

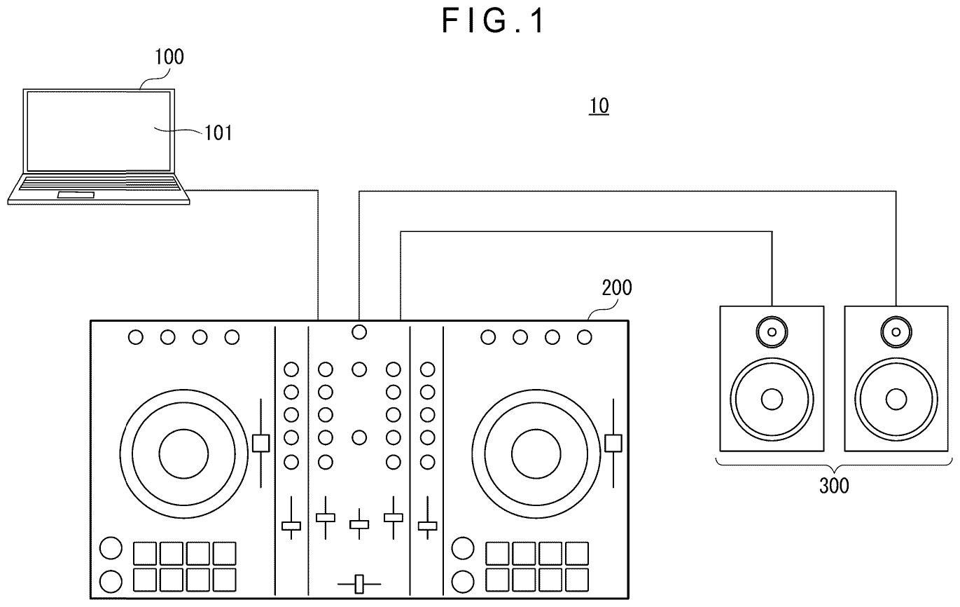

FIG. 1 illustrates an overall configuration of a system according to a first exemplary embodiment of the invention. A system 10 according to the exemplary embodiment includes a personal computer (PC) 100, a DJ controller 200, and a speaker 300. The PC 100 is a device that stores, processes, and plays back audio data. The PC 100 is not limited to a PC, and may be a terminal device such as a tablet or a smartphone. The PC 100 includes a display 101 that displays information to a user, and an input device such as a touch panel or a mouse that acquires an operation input of the user. The DJ controller 200 is coupled to the PC 100 via a communication means such as a universal serial bus (USB), for example. The DJ controller 200 acquires an operation input of the user related to playback of a music piece by a channel fader, a cross fader, a performance pad, a jog dial, various knobs, buttons, or the like. The audio data is played back by, for example, the speaker 300.

In the exemplary embodiment, the PC 100 functions as an audio data processing device in the above-described system 10. For example, the PC 100 executes a process corresponding to the user's operation input on the stored audio data when the audio data is played back. Alternatively, the PC 100 may execute the process on the audio data prior to the playback and store the processed audio data. In this case, it is not indispensable for the DJ controller 200 or the speaker 300 to be coupled to the PC 100 at the time when the process is executed. In the exemplary embodiment, the PC 100 functions as the audio data processing device; however, in another exemplary embodiment, a DJ device such as a mixer or an all-in-one DJ system (a digital audio player having communication and mixing functions) may function as the audio data processing device. Further, a server coupled to a PC or a DJ device via a network may also function as the audio data processing device.

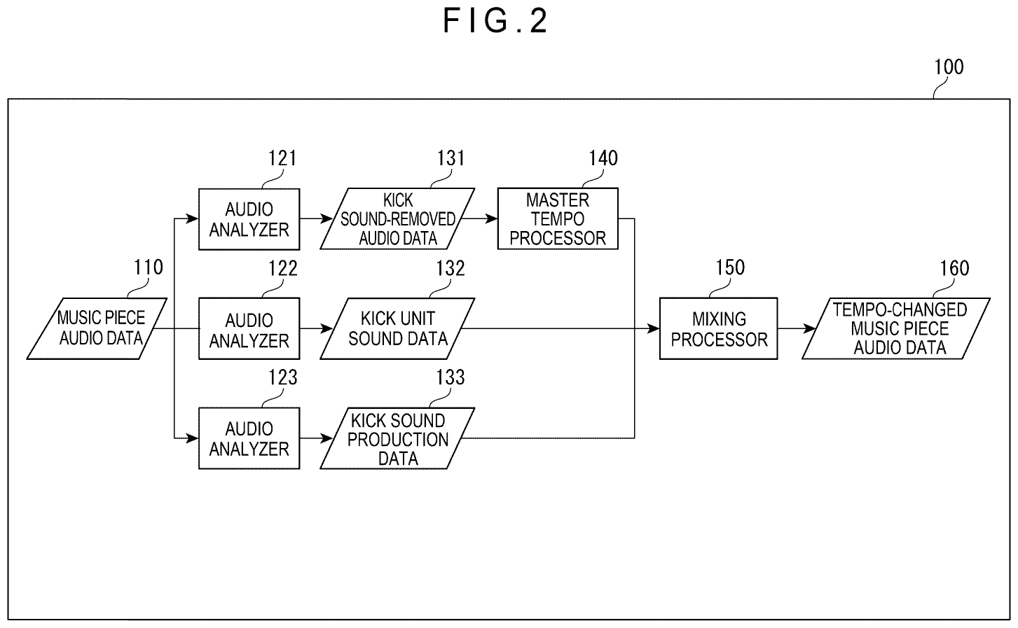

FIG. 2 is a block diagram illustrating a schematic functional configuration of the audio data processing device in an example illustrated in FIG. 1. The PC 100 that functions as the audio data processing device includes audio analyzers 121, 122, and 123, a master tempo processor 140, and a mixing processor 150. These functions are implemented by a processor such as a central processing unit (CPU) or a digital signal processor (DSP) operating in accordance with a program. The program is read from a storage of the PC 100 or a removable recording medium, or is downloaded from a server via a network and expanded in a memory of the PC 100.

Music piece audio data 110 is input to each of audio analyzers 121, 122, and 123. The music piece audio data 110 includes a first part and a second part that are acoustically separable from each other. In the exemplary embodiment, the first part is a non-kick sound part including a vocal and/or musical instrument sound, and the second part is a kick sound part. Here, the kick sound is a sound of a bass drum or a synthetic sound imitating the sound of the bass drum. The audio analyzer 121 extracts kick sound-removed audio data 131 from the music piece audio data 110 using, for example, a music separation engine. The audio analyzer 122 and the audio analyzer 123 respectively generate kick unit sound data 132 and kick sound production data 133 from the music piece audio data 110. The kick sound-removed audio data 131 is audio data in which the kick sound is removed from the music piece audio data 110, that is, audio data of the first part. The kick unit sound data 132 is data of the kick sound included in the music piece audio data 110, that is, a unit sound of the second part (hereinafter, also referred to as a kick unit sound). The kick sound production data 133 is data indicating a sounding position and a velocity of the kick sound in the music piece audio data 110.

The unit sound is a sound extracted in units of single sound production of a sound included in the second part. For example, the audio analyzer 122 extracts the unit sound by separating the kick sound part from the music piece audio data 110, partitioning the kick sound part for each piece of sound production, and classifying the pieces of sound production in accordance with audio waveform characteristics. A plurality of unit sounds having different audio waveform characteristics may be extracted. The kick unit sound data 132 may be, for example, audio data sampled from the kick sound part, information indicating a temporal position at which the unit sound is to be played back in the kick sound part, audio data of a sample sound similar to the extracted sound, or an identifier of the sample sound.

The sounding position is a temporal position at which the kick sound is to be produced in the music piece audio data 110, and is recorded, for example, in a time code or in the number of counts on a per-bar or per-beat basis within the music piece. The velocity is a parameter indicating a volume level and a length of a sound. For example, in MIDI (registered trademark), the velocity is used as a numerical value representing an intensity of a sound, more specifically, a speed of key hitting when the sound is produced by hitting a key. With an increase in the velocity, the volume level increases and the length of the sound increases. In the exemplary embodiment, the audio analyzer 123 generates the kick sound production data 133 in which the sounding position and the velocity for each of the kick sounds separated from the music piece audio data 110 are recorded.

The master tempo processor 140 performs master tempo processing on the kick sound-removed audio data 131 extracted by the audio analyzer 121. Here, the master tempo processing is a process of changing only a tempo without changing a key of the music piece. The master tempo processor 140 may make the tempo of the kick sound-removed audio data 131 faster or slower than the tempo of the original music piece audio data 110. In the exemplary embodiment, the kick sound-removed audio data 131 on which the master tempo processing is to be executed includes no kick sound. A length of a waveform of the kick sound is therefore not changed in the process performed by the master tempo processor 140.

The mixing processor 150 mixes the kick sound-removed audio data 131 subjected to the master tempo processing with audio data of the kick sound, the audio data of the kick sound being configured by relocating the kick unit sound that is based on the kick unit sound data 132 in accordance with the kick sound production data 133. The mixing processor 150 thereby generates music piece audio data 160 in which the tempo is changed. More specifically, the mixing processor 150 changes the sounding position of the kick sound indicated by the kick sound production data 133 in accordance with a tempo change rate in the master tempo processing, and sets the velocity set to the kick sound of each sounding position in the original music piece audio data 110 to the relocated kick unit sound. This makes it possible to mix the kick sound with the music piece audio data 160 in which the tempo is changed, with the same sounding position, timbre, and velocity as the original music piece audio data 110.

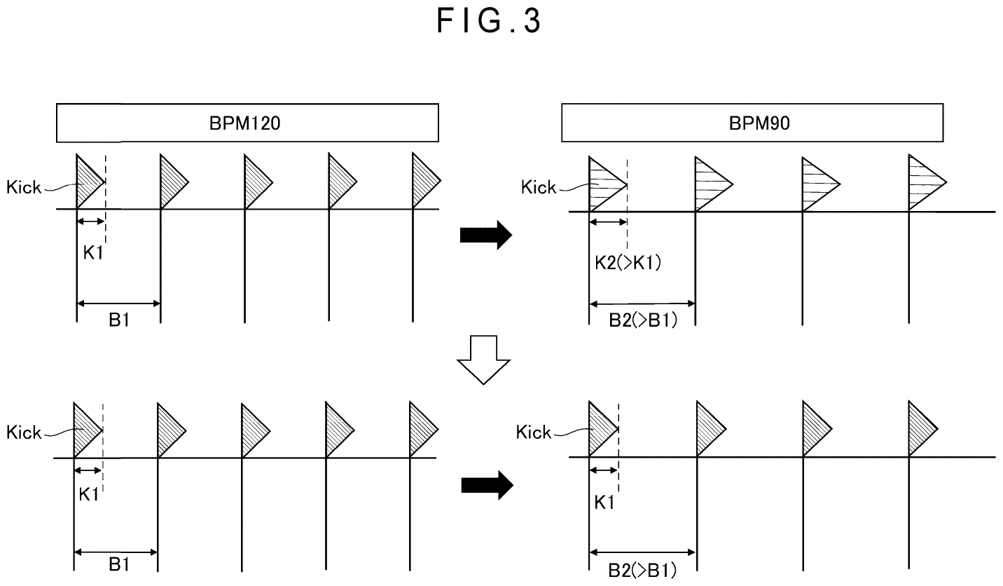

FIG. 3 schematically illustrates the master tempo processing in the example illustrated in FIG. 1 in comparison with ordinary master tempo processing. In the illustrated example, the master tempo processing of changing the music piece from 120 BPM to 90 BPM (slowing the tempo) has been executed so that a length of one beat changes from B1 to B2 (>B1). In the ordinary master tempo processing illustrated in the upper diagram, the length of the waveform of the kick sound also changes from K1 to K2 (>K1). A change in timbre of the kick sound is therefore recognizable in audio data after master tempo processing. In contrast, in the master tempo processing of the exemplary embodiment illustrated in the lower diagram, the length of the waveform of the kick sound remains to be K1 even if the length of one beat changes from B1 to B2. In practice, the kick unit sound is relocated, and the length of the waveform thus does not necessarily exactly coincide with K1. However, the length of the waveform does not change greatly, which allows the change in timbre of the kick sound to be hardly recognizable.

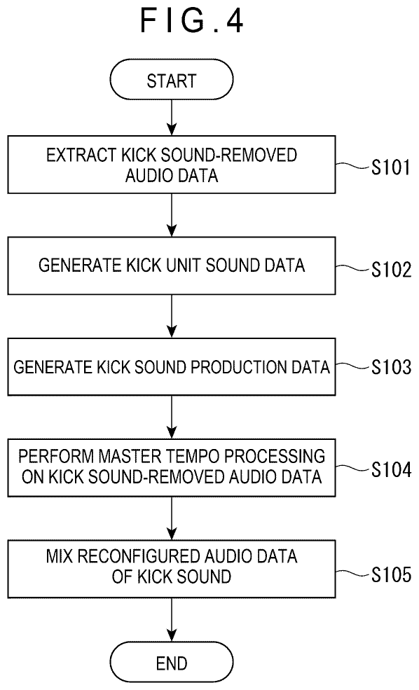

FIG. 4 is a flowchart illustrating a process performed by the audio data processing device in the example illustrated in FIG. 1. In the exemplary embodiment: the kick sound-removed audio data 131 is extracted from the music piece audio data 110 by the audio analyzer 121, the kick unit sound data 132 is generated from the music piece audio data 110 by the audio analyzer 122, and the kick sound production data 133 is generated from the music piece audio data 110 by the audio analyzer 123 (steps S101 to S103, in random order); the kick sound-removed audio data 131 is subjected to the master tempo processing (step S104); and the audio data of the kick sound that is reconfigured based on the kick unit sound data 132 and the kick sound production data 133 is mixed with the kick sound-removed audio data 131 subjected to the master tempo processing (step S105). The music piece audio data 160 in which the tempo is changed is thereby generated.

In the above-described first exemplary embodiment of the invention, when the tempo of the original music piece audio data 110 is to be changed, the kick sound-removed audio data 131 extracted by the audio analyzer 121 is subjected to the master tempo processing, and the kick sound-removed audio data 131 subjected to the master tempo processing is mixed with the audio data of the kick sound, the audio data of the kick sound being configured by relocating the kick unit sound that is based on the kick unit sound data 132 in accordance with the kick sound production data 133. This makes it possible to produce the kick sound in the music piece audio data 160 in which the tempo is changed, without allowing the change in timbre to be recognized and at the same sounding position as in the original music piece audio data 110.

### Second Exemplary Embodiment

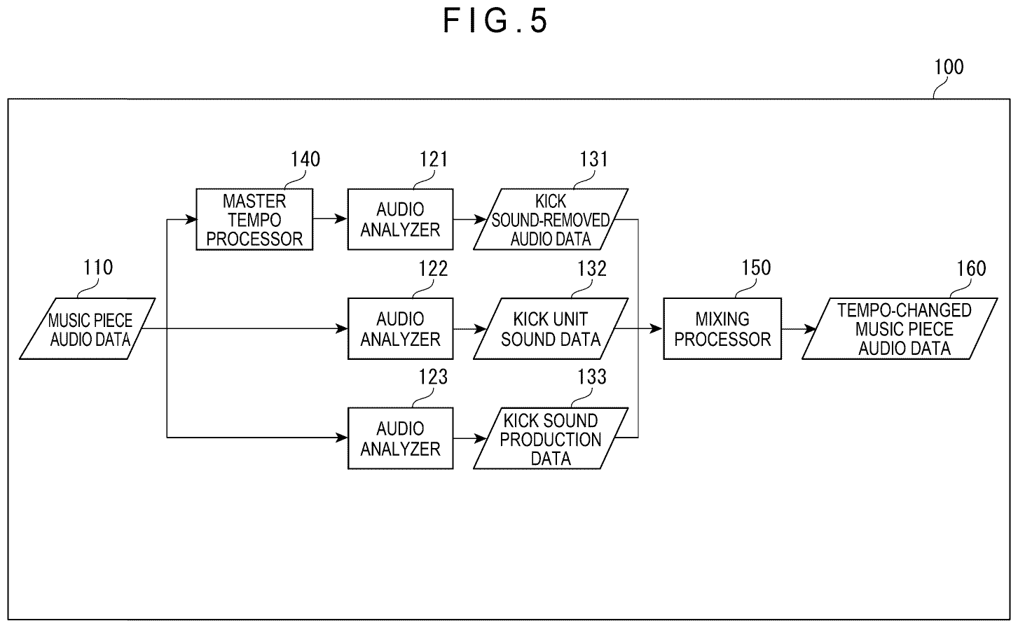

FIG. 5 is a block diagram illustrating a schematic functional configuration of an audio data processing device according to a second exemplary embodiment of the invention. Configurations of the second exemplary embodiment are similar to those of the first exemplary embodiment except for a location of the master tempo processor 140 and the order of processes to be described below, and thus repeated detailed description thereof is omitted.

In the exemplary embodiment, the master tempo processor 140 performs master tempo processing on the music piece audio data 110, and the audio analyzer 121 extracts the kick sound-removed audio data 131 from the music piece audio data 110 subjected to the master tempo processing. Here, the music piece audio data 110 is subjected to the master tempo processing with the kick sound being contained therein. The length of the waveform of the kick sound thus has changed as described above with reference to FIG. 3. Extracting the kick sound-removed audio data 131 from the music piece audio data 110 makes it possible to remove the kick sound whose length of the waveform is changed, and to obtain the kick sound-removed audio data 131 subjected to the master tempo processing that is similar to that of the first exemplary embodiment.

In contrast, the audio analyzer 122 and the audio analyzer 123 respectively generate the kick unit sound data 132 and the kick sound production data 133 from the music piece audio data 110 before being subjected to the master tempo processing, as with the first exemplary embodiment. The mixing processor 150, as with the first exemplary embodiment, mixes the audio data of the kick sound that is reconfigured based on the kick unit sound data 132 and the kick sound production data 133 with the kick sound-removed audio data 131. The mixing processor 150 thereby generates the music piece audio data 160 in which the tempo is changed.

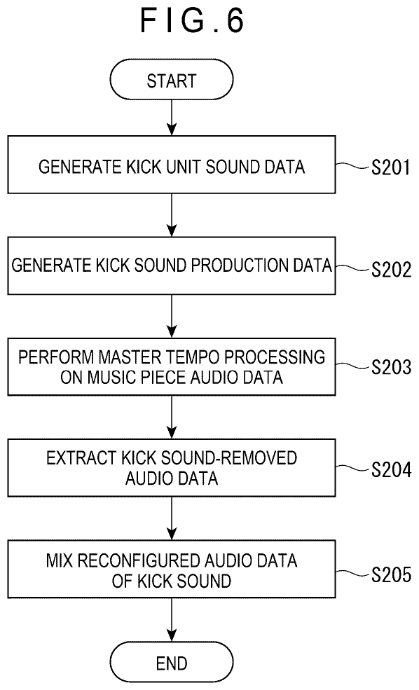

FIG. 6 is a flowchart illustrating a process performed by the audio data processing device in the example illustrated in FIG. 5. In the exemplary embodiment: the kick unit sound data 132 and the kick sound production data 133 are respectively generated by the audio analyzers 122 and 123 from the music piece audio data 110 that is prior to being subjected to the master tempo processing (steps S201 and S202, in random order); the music piece audio data 110 is subjected to the master tempo processing (step S203); the kick sound-removed audio data 131 is extracted by the audio analyzer 121 from the music piece audio data 110 subjected to the master tempo processing (step S204); and the audio data of the kick sound that is reconfigured based on the kick unit sound data 132 and the kick sound production data 133 is mixed with the kick sound-removed audio data 131 (step S205). The music piece audio data 160 in which the tempo is changed is thereby generated.

In the second exemplary embodiment of the invention described above, the kick sound-removed audio data 131 is extracted after the music piece audio data 110 is subjected to the master tempo processing. In this case also, the kick sound-removed audio data 131 subjected to the master tempo processing is mixed with the audio data of the kick sound, the audio data of the kick sound being configured by relocating the kick unit sound that is based on the kick unit sound data 132 in accordance with the kick sound production data 133. This makes it possible to produce the kick sound in the music piece audio data 160 in which the tempo is changed, without allowing the change in timbre to be recognized and at the same sounding position as the original music piece audio data 110, as with the first exemplary embodiment.

It is to be noted that the exemplary embodiments described above are each an example, and are modifiable in various ways. For example, in each of the above exemplary embodiments, the description is given of the case where the first part of the music piece is the non-kick sound part and the second part of the music piece is the kick sound part. However, it is not limited as to how to separate vocal and/or musical instrument sounds and allocate them into the first part and the second part. The second part may be a part from which a unit sound is extractable, and may be, for example, a part of a hi-hat or a snare drum, or a part of a percussion instrument sound including a drum sound in which a hi-hat or a snare drum is added to a kick sound. As described above, it is possible to extract a plurality of unit sounds having different audio waveform characteristics. Therefore, the second part may be a part of the drum sound, and the kick unit sound and the unit sounds of the hi-hat and the snare drum may each be relocated.

### EXPLANATION OF CODES

10 . . . system, 100 . . . PC, 101 . . . display, 110 . . . music piece audio data, 121 . . . audio analyzer, 122 . . . audio analyzer, 123 . . . audio analyzer, 131 . . . kick sound-removed audio data, 132 . . . kick unit sound data, 133 . . . kick sound production data, 140 . . . master tempo processor, 150 . . . mixing processor, 160 . . . music piece audio data, 200 . . . DJ controller, 300 . . . speaker.

1. An audio data processing device comprising:
a first audio analyzer configured to extract, from audio data of a music piece including a first part and a second part that are acoustically separable from each other, audio data of the first part;
a second audio analyzer configured to generate, from the audio data of the music piece, data of a unit sound of the second part;
a third audio analyzer configured to generate, from the audio data of the music piece, data indicating a sounding position of the second part;
a master tempo processor configured to perform master tempo processing on audio data including at least the first part; and
a mixing processor configured to generate audio data in which the audio data subjected to the master tempo processing is mixed with audio data of the second part, the audio data of the second part being configured by relocating the unit sound of the second part in accordance with the data indicating the sounding position of the second part.

2. The audio data processing device according to claim 1, wherein the master tempo processor is configured to perform master tempo processing on the audio data of the first part.

3. The audio data processing device according to claim 1, wherein
the master tempo processor is configured to perform master tempo processing on the audio data of the music piece,
the first audio analyzer is configured to extract, from the audio data of the music piece subjected to the master tempo processing, the audio data of the first part, and
the second audio analyzer is configured to generate, from the audio data of the music piece before being subjected to the master tempo processing, the data of the unit sound of the second part.

4. The audio data processing device according to claim 1, wherein
the second part includes a percussion instrument sound, and
the first part includes a sound other than the percussion instrument sound.

5. The audio data processing device according to claim 4, wherein the percussion instrument sound includes a kick sound.

6. An audio data processing method comprising:
extracting, from audio data of a music piece including a first part and a second part that are acoustically separable from each other, audio data of the first part;
generating, from the audio data of the music piece, data of a unit sound of the second part;
generating, from the audio data of the music piece, data indicating a sounding position of the second part;
performing master tempo processing on audio data including at least the first part; and
generating audio data in which the audio data subjected to the master tempo processing is mixed with audio data of the second part, the audio data of the second part being configured by relocating the unit sound of the second part in accordance with the data indicating the sounding position of the second part.

7. A tangible and non-transitory storage medium storing a program for causing a computer to achieve functions of:
extracting, from audio data of a music piece including a first part and a second part that are acoustically separable from each other, audio data of the first part;
generating, from the audio data of the music piece, data of a unit sound of the second part;
generating, from the audio data of the music piece, data indicating a sounding position of the second part;
performing master tempo processing on audio data including at least the first part; and
generating audio data in which the audio data subjected to the master tempo processing is mixed with audio data of the second part, the audio data of the second part being configured by relocating the unit sound of the second part in accordance with the data indicating the sounding position of the second part.
